(19) United States
(12) Patent Application Publication
(10) Pub. No.: US 2006/0149638 A1
(43) Pub. Date: Jul. 6, 2006

(54) Electronic personalized clothing makeover assistant

(76) Inventor: Anita L. Allen, Roanoke, TX (US)

Correspondence Address: STEPHEN R. LOE, THE LAW OFFICE OF STEPHEN R. LOE, P.O. BOX 649, FRISCO, TX, 75034, US

(21) Appl. No.: 11/030,023

(22) Filed: Jan. 6, 2005

(51) Int. Cl. G06Q 30/00

(52) U.S. Cl. 705/26

(57) ABSTRACT

A method, system, and computer program product for customizing the display of clothing for sale by an enterprise over the Internet so as to view it as it would appear on the body of a particular person specified by a user is provided. In one embodiment, a digitized image of a person selected by a user is received by a server via the Internet. Dimension and scaling information regarding the image of the person are also received from the user. The enterprise's server then receives a selection of a clothing item that the user would like to see the image of the person wearing. The server scales the image of either the image of the person, the image of clothing item selected by the user, or both so that the image of the clothing item will fit the image of the person appropriately. An image of the person wearing the clothing item selected by the user is then created and presented to the user.

### BACKGROUND OF THE INVENTION

1. Technical Field

The present invention relates to computer software and, more particularly to software for manipulating images of people and clothing to aid in selection of clothing.

2. Description of Related Art

The “Internet” is a worldwide network of computers. Today, the Internet is made up of more than 65 million computers in more than 100 countries covering commercial, academic and government endeavors. Originally developed for the U.S. military, the Internet became widely used for academic and commercial research. Users had access to unpublished data and journals on a huge variety of subjects. Today, the Internet has become commercialized into a worldwide information highway, providing information on every subject known to humankind.

The Internet's surge in growth in the latter half of the 1990s was twofold. As the major online services (AOL, CompuServe, etc.) connected to the Internet for e-mail exchange, the Internet began to function as a central gateway. A member of one service could finally send mail to a member of another. The Internet glued the world together for electronic mail, and today, the Internet mail protocol is the world standard.

Secondly, with the advent of graphics-based Web browsers such as Mosaic and Netscape Navigator, and soon after, Microsoft's Internet Explorer, the World Wide Web took off. The Web became easily available to users with PCs and Macs rather than only scientists and hackers at UNIX workstations. Delphi was the first proprietary online service to offer Web access, and all the rest followed. At the same time, new Internet service providers rose out of the woodwork to offer access to individuals and companies. As a result, the Web has grown exponentially providing an information exchange of unprecedented proportion. The Web has also become “the” storehouse for drivers, updates and demos that are downloaded via the browser.

With the Internet's rapid growth in use and popularity has come an increase in the use of the Internet for shopping. Shopping for clothing over the Internet, for example, has become a multi-million, perhaps even multi-billion, dollar enterprise. One reason for the popularity of shopping for clothing over the Internet is the ease of use and convenience of shopping from home rather than having to fight traffic to get to a store and then fight crowds of people once there.

However, one disadvantage of shopping over the Internet is the inability to accurately determine whether a particular style and/or color of clothing is flattering and appealing when worn by the particular individual. Thus, people may often end up with clothing that appears good when viewed on the Internet, but is not flattering on the person when the clothing actually arrives. Therefore, it would be desirable to have a method, system, and computer program product that allows a user to make a more informed choice as to what clothing to purchase over the Internet.

### SUMMARY OF THE INVENTION

The present invention provides a method, system, and computer program product for customizing the display of clothing for sale by an enterprise over the Internet so as to view it as it would appear on the body of a particular person specified by a user or for a particular body type. In one embodiment, a digitized image of a person selected by a user is received by a server via the Internet. Dimension and scaling information regarding the image of the person are also received from the user. The enterprise's server then receives a selection of a clothing item that the user would like to see the image of the person wearing. The server scales the image of either the image of the person, the image of clothing item selected by the user, or both so that the image of the clothing item will fit the image of the person appropriately. An image of the person wearing the clothing item selected by the user is then created and presented to the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3 depicts a block diagram of a data processing system in which the present invention may be implemented;

FIG. 4 depicts a pictorial diagram illustrating an exemplary user interface for viewing clothing options on an image of a user in accordance with one embodiment of the present invention;

FIG. 5 depicts a diagram illustrating an exemplary process flow and program function for displaying customizable images of a user wearing various selectable clothing options in accordance with one embodiment of the present invention; and

FIG. 6 depicts a diagram illustrating an exemplary process flow and program function for allowing a user to select a body type and clothing choice and then see a model of the selected body type wearing the clothing choice in accordance with one embodiment of the present invention.

### DETAILED DESCRIPTION OF THE PREFERRED EMBODIMENT

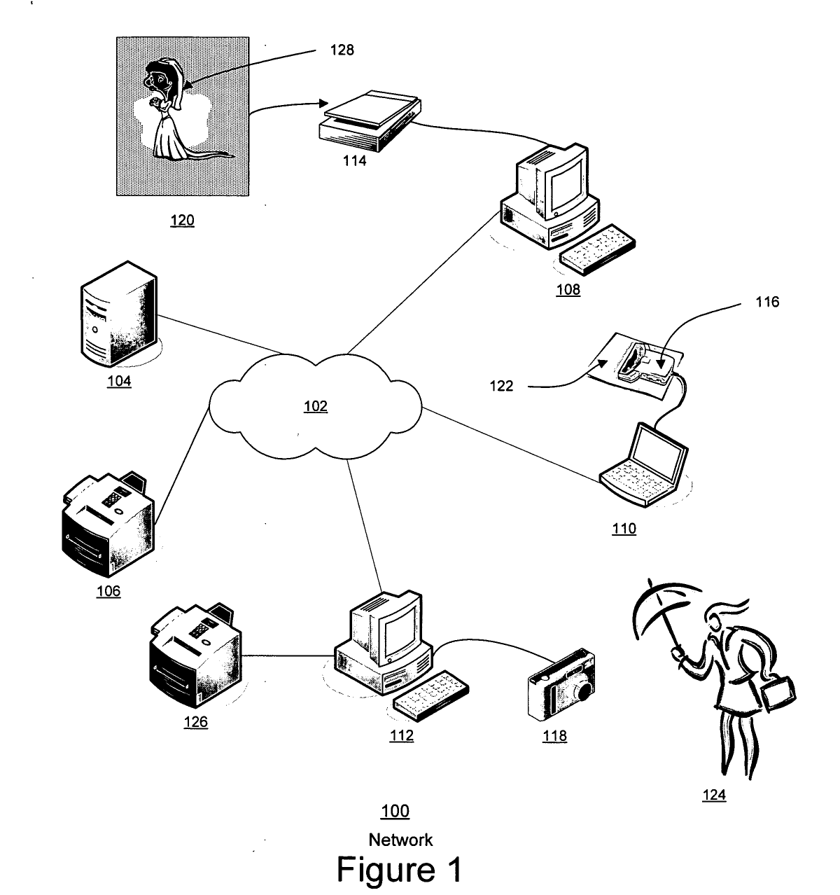

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with printer 106. In addition, clients 108, 110 and 112 are also connected to network 102. These clients, 108, 110 and 112, may be, for example, personal computers or laptop computers. A flatbed scanner 114 is connected to client 108 allowing digitized images of pictures, such as, for example, picture 120 of person 128, to be loaded into data processing system 108 for manipulation by data processing system 108 or server 104. A handheld scanner 116 is connected to laptop computer 110 allowing digitized images of photographs or pictures 122 to be loaded into laptop 110. A digital camera 118 is connected to client 112. Camera 118 may take photographs of a person, such as, for example, person 124 and download these images into client 112. A printer 126 is also connected to client 112, thereby allowing the photographs to be printed.

In the depicted example, server 104 provides a web page to allow consumers to provide pictures of a person that they desire to view various clothing options on in order to see how that clothing style would appear on that person. Server 104 may also provide software allowing the consumer, once the user's picture has been uploaded to server 104, to view the picture with various items changed to show how the person would look with various styles of clothing. In one embodiment, the server 104 could allow the user to select certain areas of the picture, perhaps by using a mouse and cursor to draw lines around an area of the picture, and have this area of the picture changed using decor provided by the online retailer operating server 104. For example, the area selected by the user could correspond to the torso of the person allowing an image of a blouse or shirt to be displayed over this area of the person's image in order to demonstrate how the blouse or shirt would appear on the person. The user could then select a clothing colors and or prints offered by the retailer and have the blouse or shirt color and fabric pattern changed to match the selected color and or fabric pattern. Thus, the user could see how the person would look with various colors and or fabric patterns without the necessity of actually going to a store and trying on clothes, thereby saving untold hours of time going to stores to shop. The user could also select various clothing styles as well.

In one example, a user could take a picture 120 of a person and scan the picture into a client 108 using a scanner 114. Once a digitized image of the picture 120 has been created, the picture 120 is uploaded to server 104 which then provides tools for manipulating the picture to see how various clothing options appear on the person 128 represented by picture 120. For example, various types of dresses could be selected from a menu of dress options and these dresses superimposed over the image of the person at the appropriate location. In order to determine the appropriate positioning of clothing, the server may request that the user provide measurements, such as, for example, height, waist, and inseam. The server may also request that the user position a cursor over various points on the image to indicate the location of the various body parts, such as, for example, waist, shoulder, etc. Based on the location provided by the user of the various body parts and the dimensions provided by the user, the server then scales an image of the clothing selected by the user appropriately and displays the image of the clothing over the appropriate area of the image of the person. In other embodiments, the user may drag and drop an image of the clothing onto the image of the person and may resize the image of the clothing appropriately to fit the image of the person or resize the image of the person to fit the clothing image size. These examples of manipulations that may be performed on picture 120, however, are merely presented as examples and not as limitations of the present invention. As those skilled in the art will recognize, the picture 120 may be manipulated in a myriad of ways to demonstrate how a person would appear in various clothing styles.

In addition to viewing the image of the person appearing to wear various clothing, the user may print one or more images to either a directly connected printer, such as, for example, printer 126, or to a network printer, such as, for example, printer 106. In this way, the user may have a hard copy to look at rather than an image displayed on a computer screen. Such an option may be preferable for some users.

In other embodiments, rather than receiving an image of the user, a user may select a body type from a listing of body types. The user may then select a clothing option or, alternatively, have clothing options selected for the user based on the body type. The user may have a selected clothing option presented to them being worn by a model of the selected body type. Examples of body types include tall and willowy; dwarfed frames; pear- or apple-shaped frames; average frames; heavy set, extra-long or -tall; etc. Clothing appropriate for various body types may be determined by an expert or other person and the inventory listing of clothing may be tagged to indicate which body type or types the clothing is most suitable. The inventory or item listing may also indicate what climates the items is suitable for as well as what fashion category it belongs to (e.g., business attire, casual, fad, etc.) as well as type of fabric from which the clothing item is constructed. In some embodiments, the user may select from these additional choices (i.e., fashion category, fabric, climate, etc.) and narrow suitable choices.

Alternatively, rather than having a data processing system narrow the choices, the customer's image details and the customer's preferences (e.g., fashion style, fabric preference, etc.) may be presented to a fashion advisor who then selects items that would be most flattering on the customer and which meet the customer's other criteria.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network.

FIG. 1 is intended as an example and not as an architectural limitation for the processes of the present invention.

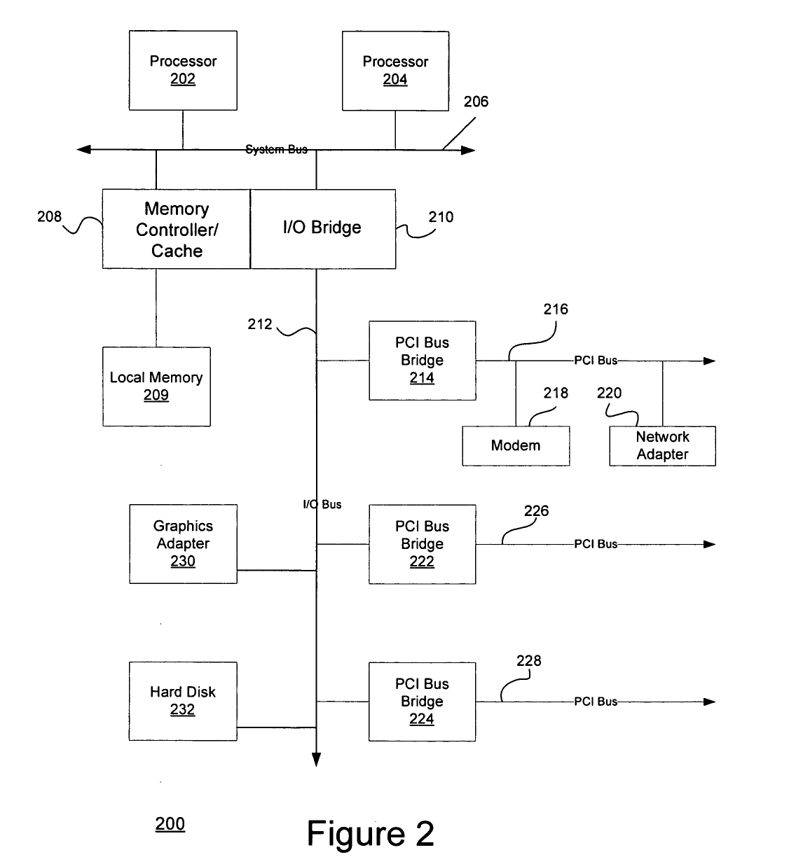

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

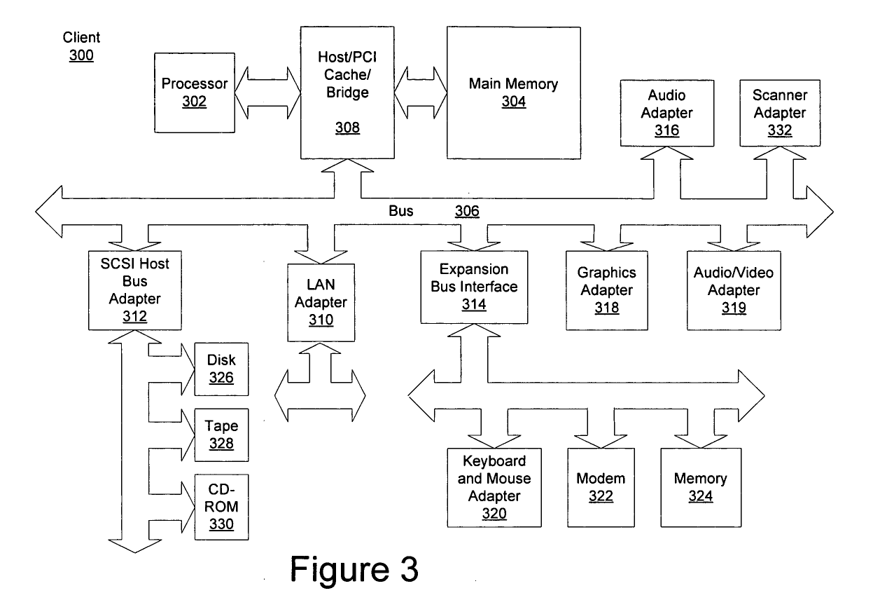

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

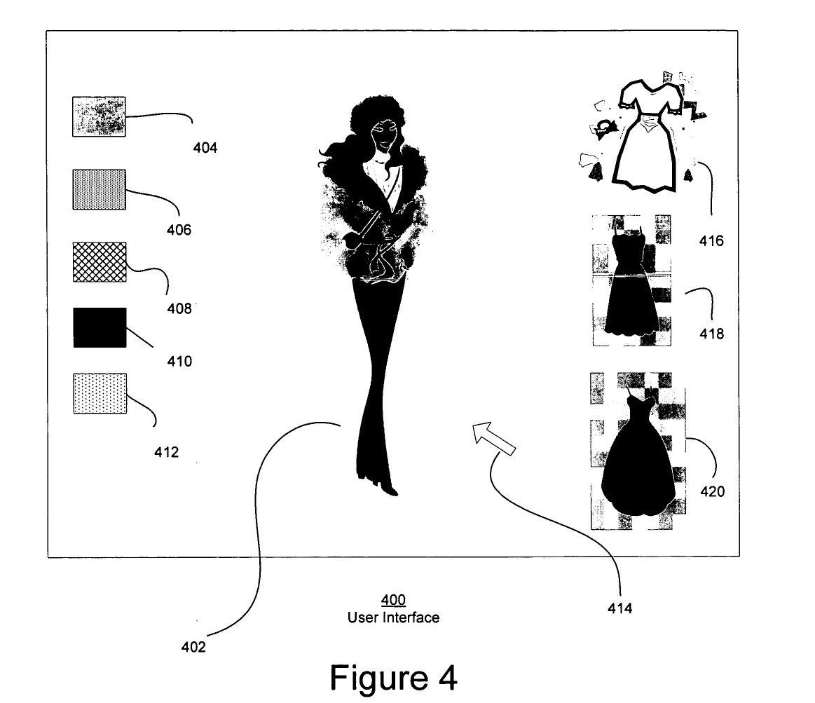

With reference now to FIG. 4, a pictorial diagram illustrating an exemplary user interface for viewing clothing options on an image of a user is depicted in accordance with one embodiment of the present invention. User interface 400 includes an area for displaying an image of a person 402 received from a user. User interface 400 may also include a palette of clothing fabric colors and/or fabric patterns 404-412 which may be selected by the user utilizing, for example, a cursor 414. Once a fabric color or pattern 404-412 has been selected, the image of the person 402 is modified such that the clothing selection displayed on the person 402 is changed to show the newly selected fabric color or pattern 404-412.

User interface 400 may also include a section displaying one or more clothing options 416-420 that the user may select to be displayed on the image of the person 402. When a particular clothing option 416-420 is selected, the image of the person 402 is changed to display the person wearing the clothing selected from the options 416-420. User interface 400 is presented merely as an example of a user interface that may be utilized in accordance with the present invention and is not intended to be an architectural limitation to the present invention.

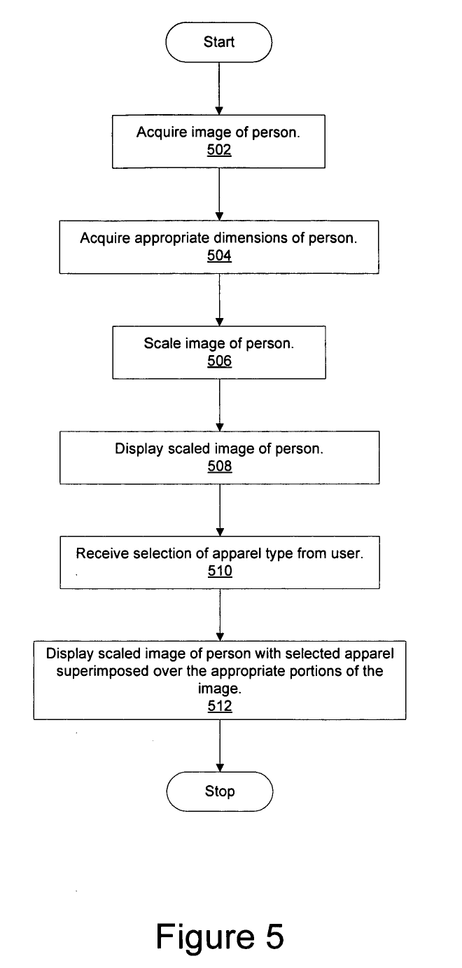

With reference now to FIG. 5, a diagram illustrating an exemplary process flow and program function for displaying customizable images of a user wearing various selectable clothing options is depicted in accordance with one embodiment of the present invention. To begin, an image of a person is acquired by a server via, for example, the Internet (step 502). The server then acquires appropriate dimensions of the person, such as, for example, height, inseam, waist, neck size, dress size, etc. (step 504). The server may also display the image to the user and request that the user select various points on the image corresponding to body areas that the server may inquire about in order to determine the scale of the image and how clothing will fit on the image.

Once the serve has acquired the image and the person's dimensions and correlated the dimensions to points on the image, the server may then scale the image of the person appropriately such that the images of the clothing stored, for example, on the web enterprise's storage device, will fit the image of the person (step 506). Alternatively, the server may rescale the images of the clothing such that the images of the clothing will fit appropriately on the image of the person received from the user.

The server creates a web page with the image of the person located in the web page as well as selectable options allowing the user to view various clothing options on the image of the person and sends the web page to the user's computer for presentation to the user (step 508). The user may then make various selections utilizing the selection mechanisms provided in the web page in order to select a style, pattern, and color of clothing to be displayed on the image of the person. The server receives these selections and modifies the web page to display the image of the person with the image of the selected apparel superimposed over the appropriate portions of the image of the person and sends this modified web page to the user's computer for presentation to the user (step 512).

After viewing one or more clothing options on the person to see how various clothing options appear when worn by that person, the user may then decide to purchase one or more of the clothing items offered for sale by an enterprise operating the web site. However, because the user was allowed to see how the clothing would appear when worn by the person for which the clothing are being purchased rather than on a generic model, the possibility of the item being returned because the purchaser is unhappy with the purchasing decision is reduced. This results in lower costs for the enterprise. This also has the additional advantage of making it more likely that the customer is happy with their decision and may be more likely to return to the on-line retailer for future purchases. Thus, the present invention provides advantages to both the customer and the retailer.

In some embodiments, the image can be saved either, for example, to storage operated by the web site such that the user can retrieve the image merely by, for example, logging back into their account on the web site, or, alternatively, the image can be saved to a local storage device. In either of these two embodiments, the user does not have to take another photograph. However, the option of storing the image through the web site is more convenient for the user since the user does not have to retransmit their image to the web site, but merely retrieves the image via the web site. It is possible that in some embodiments that retailers may share the image with other retailers thereby saving the user from having to retransmit the image to each web site that the user visits. Such an embodiment would probably typically require the consent of the user for sharing the image.

In other embodiments, the on-line retailer may offer a service where fashion advisors look at the person's physique and physical elements (e.g., hair color, eye color, face shape, etc.) visible in the image transmitted to the retailer by the user and assist the person in choosing clothes that are flattering to that person's physical appearance in terms of, for example, color, style, and fabric. The user may also transmit or select from a graphical user interface of choices, certain qualities or lifestyle preferences to aid the advisor in selecting appropriate items. For example, the user may indicate, for example, that they work in a business professional setting, or, alternatively, that they work in a business casual setting. The user may also indicate the weather type for which the clothing is being purchased. For example, clothing suitable for a tropical climate would not be suitable for an arctic climate and vice versa. The person may also indicate what types of fashion that the person prefers (e.g., casual or business attire, fad or traditional tailored attire, etc.) as well as fabric preferences (e.g., cotton, wool, polyester, nylon, linen, silk, etc.). Thus, it is more likely that the clothing selected for the person by the fashion advisor will meet the person's needs since the fashion advisor is aided by having the image of the person as well as information about the person's tastes, requirements, and climatic conditions of the area that the person intends to wear the clothing.

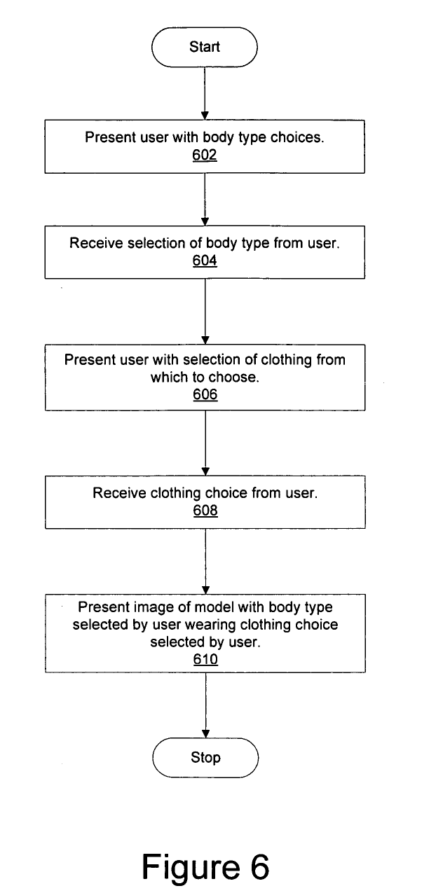

With reference now to FIG. 6, a diagram illustrating an exemplary process flow and program function for allowing a user to select a body type and clothing choice and then see a model of the selected body type wearing the clothing choice is depicted in accordance with one embodiment of the present invention. To begin, when a user accesses the retailer's web site, the user is presented with an interface allowing the user to select a body type (step 602). The interface may contain an image or representation of the body type or merely have a description of the body type. Once the user selects a body type, the web site receives the selection (step 604). The web site also presents the user with a selection of clothing from which to choose (step 606). Methods of allowing a user to locate and select clothing items are well known in the art. Once the user has selected the clothing option, this option is transmitted to the web site which receives the information and begins processing the selections to create or select an image matching the user's selection options (step 608). The clothing option may include, for example, both a style and a color option. Other options may also be included. Note that the ordering of selection of body type and clothing choice is not important.

Once the web site receives the body type and clothing options from the user and has created an appropriate image, the web site creates a web page and presents the user with an image of a model with the body type specified wearing the clothing choice selected by the user (step 610). This image of the model of the specified type wearing the specified clothing may be an image that is created and stored in a quasi-permanent manner and merely retrieved when a user requests the corresponding specifications or may be dynamically created by merging and/or manipulating an image of a model with that of the appropriate clothing to produce an image of a model of the appropriate body type wearing the specified clothing. This embodiment has the advantage of not requiring the user to divulge personal information like their image to an impersonal retailer as well as saves on band width by not requiring the transmission, at least initially, of an image of the user. This embodiment is also useful for allowing a user who is shopping for someone else to determine how a piece of clothing would look on another person without acquiring an image of that person to send to the web site. However, it lacks the ability to demonstrate to the user exactly how a specific choice of clothing would look on the particular user.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links. The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for customizing the display of clothing for sale on the Internet, the method comprising:
receiving a digitized image of a person selected by a user;
receiving dimension and scaling information from the user;
receiving a selection of a clothing item that the user would like to see the image of the person wearing;
scaling the image of at least one of the image of the person and the image of clothing item selected by the user;
creating an image of the person wearing the clothing item selected by the user; and
presenting the image of the person wearing the clothing item selected by the user to the user.

2. The method as recited in claim 1, wherein creating an image of the person wearing the clothing item selected by the user comprises generating a web page.

3. The method as recited in claim 1, wherein a web page is generated and presented to the user, wherein the web page contains interactive elements allowing the user to select a clothing option.

4. The method as recited in claim 1, wherein creating an image of the person wearing the clothing item selected by the user comprises receiving drag and drop instructions from a user.

5. The method as recited in claim 1, wherein scaling the image of at least one of the image of the person and the image of clothing item selected by the user comprises receiving resizing instructions from the user based on cursor position and movement.

6. The method as recited in claim 1, further comprising:
receiving user preference selections;
presenting the image of the person and the user preference selections to a fashion advisor;
receiving clothing options from the fashion advisor; and
presenting the clothing options to the user.

7. The method as recited in claim 6, wherein the user preference selections comprises at least one of fabric preferences, style preferences, and climate conditions in which the clothing will be worn.

8. A computer program product in a computer readable media for use in a data processing system for customizing the display of clothing for sale on the Internet, the computer program product comprising:
first instructions for receiving a digitized image of a person selected by a user;
second instructions for receiving dimension and scaling information from the user;
third instructions for receiving a selection of a clothing item that the user would like to see the image of the person wearing;
fourth instructions for scaling the image of at least one of the image of the person and the image of clothing item selected by the user;
fifth instructions for creating an image of the person wearing the clothing item selected by the user; and
sixth instructions for presenting the image of the person wearing the clothing item selected by the user to the user.

9. The computer program product as recited in claim 8, wherein creating an image of the person wearing the clothing item selected by the user comprises generating a web page.

10. The computer program product as recited in claim 8, wherein a web page is generated and presented to the user, wherein the web page contains interactive elements allowing the user to select a clothing option.

11. The computer program product as recited in claim 8, wherein creating an image of the person wearing the clothing item selected by the user comprises receiving drag and drop instructions from a user.

12. The computer program product as recited in claim 8, wherein scaling the image of at least one of the image of the person and the image of clothing item selected by the user comprises receiving resizing instructions from the user based on cursor position and movement.

13. The computer program product as recited in claim 8, further comprising:
seventh instructions for receiving user preference selections;
eighth instructions for presenting the image of the person and the user preference selections to a fashion advisor;
ninth instructions for receiving clothing options from the fashion advisor; and
tenth instructions for presenting the clothing options to the user.

14. The computer program product as recited in claim 13, wherein the user preference selections comprises at least one of fabric preferences, style preferences, and climate conditions in which the clothing will be worn.

15. A system for customizing the display of clothing for sale on the Internet, the system comprising:
first means for receiving a digitized image of a person selected by a user;
second means for receiving dimension and scaling information from the user;
third means for receiving a selection of a clothing item that the user would like to see the image of the person wearing;
fourth means for scaling the image of at least one of the image of the person and the image of clothing item selected by the user;
fifth means for creating an image of the person wearing the clothing item selected by the user; and
sixth means for presenting the image of the person wearing the clothing item selected by the user to the user.

16. The system as recited in claim 15, wherein creating an image of the person wearing the clothing item selected by the user comprises generating a web page.

17. The system as recited in claim 15, wherein a web page is generated and presented to the user, wherein the web page contains interactive elements allowing the user to select a clothing option.

18. The system as recited in claim 15, wherein creating an image of the person wearing the clothing item selected by the user comprises receiving drag and drop means from a user.

19. The system as recited in claim 15, wherein scaling the image of at least one of the image of the person and the image of clothing item selected by the user comprises receiving resizing means from the user based on cursor position and movement.

20. The system as recited in claim 15, further comprising:
seventh means for receiving user preference selections;
Eighth means for presenting the image of the person and the user preference selections to a fashion advisor;
ninth means for receiving clothing options from the fashion advisor; and
tenth means for presenting the clothing options to the user.

21. The system as recited in claim 20, wherein the user preference selections comprises at least one of fabric preferences, style preferences, and climate conditions in which the clothing will be worn.

22. A method for aiding a customer in selecting clothing via a networked data processing system, the method comprising:
presenting a user with body type and clothing options;
receiving a user selection of body type and clothing option;
generating an image of a model of the selected body type wearing the selected clothing; and
presenting the image of the model to the user.

23. The method as recited in claim 22, wherein the generating the image of a model of the selected body type wearing the selected clothing comprises retrieving an image of the model wearing the clothing type from storage.

24. The method as recited in claim 22, wherein the generating the image of a model of the selected body type wearing the selected clothing comprises dynamically creating the image utilizing a stock image of a model of the specified body type and manipulating the image to create the image of a model of the selected body type wearing the selected clothing.

25. The method as recited in claim 22, further comprising:
prior to receiving a clothing selection from the user, determining clothing options suitable for the selected body type; and
presenting these clothing options to the user.

26. The method as recited in claim 25, further comprising:
prior to presenting the user with clothing options, presenting the user with preference options; and
receiving user preferences; and
determining clothing options which match the selected body type and user preferences.
